(19) United States
(12) Patent Application Publication
(10) Pub. No.: US 2026/0162611 A1
(43) Pub. Date: Jun. 11, 2026

(54) LIGHT EMITTING DISPLAY APPARATUS

(71) Applicant: LG DISPLAY CO., LTD., Seoul (KR)

(72) Inventors: Jae-Woong YOUN, Paju-si (KR); Ji-Woong Park, Paju-si (KR)

(73) Assignee: LG DISPLAY CO., LTD., Seoul (KR)

(21) Appl. No.: 19/342,339

(22) Filed: Sep. 26, 2025

(30) Foreign Application Priority Data
Dec. 9, 2024 (KR) 10-2024-0181722

(51) Int. Cl. G09G 3/3233

(52) U.S. Cl. CPC G09G 3/3233; G09G 2300/0819; G09G 2300/0852; G09G 2300/0861; G09G 2310/066; G09G 2320/0233; G09G 2320/0257; G09G 2320/048

(57) ABSTRACT

A light emitting display apparatus can include a display panel having pixels each having a light emitting diode, a driving transistor, and a first capacitor connected between a source electrode and a gate electrode of the driving transistor, a timing control portion including a stress calculation portion configured to calculate a stress data representing an amount of stress accumulated in the driving transistor of the pixel using an image data input in a display driving, and a recovery data generation portion configured to generate a recovery data corresponding to the calculated stress data in a recovery driving, and a data driving portion configured to output a recovery voltage corresponding to the recovery data to a data line. The recovery voltage is configured to be applied to the driving transistor of the pixel such that a gate-source voltage of the driving transistor is in a reverse bias state.

### CROSS-REFERENCE TO RELATED APPLICATIONS

The present application claims priority to Korean Patent Application No. 10-2024-0181722, filed in Republic of Korea on Dec. 9, 2024, which is hereby expressly incorporated by reference in its entirety for all purposes as if fully set forth herein.

### BACKGROUND

### Field of the Invention

The present disclosure relates to a light emitting display apparatus.

### Discussion of the Related Art

As the information society develops, a demand for display apparatuses for displaying images has increased in various forms. In recent years, various flat display apparatuses such as organic light emitting display apparatuses and liquid crystal display apparatuses have been used.

A light emitting display apparatus has been configured using oxide transistors. Compared to a polycrystalline silicon transistor, the oxide transistor can be vulnerable to stress, so that the oxide transistor can have a degradation such as a threshold voltage shift. This can cause poor image quality such as afterimages and brightness fluctuations.

### SUMMARY OF THE DISCLOSURE

An advantage of the present disclosure is to provide a display apparatus that can reduce or minimize degradation of an oxide transistor vulnerable to stress and improving image quality.

Another object of the present disclosure is to provide an improved display apparatus which addresses the limitations and disadvantages associated with the related art.

Additional features and advantages of the disclosure will be set forth in the description which follows, and in part will be apparent from the description, or can be learned by practice of the disclosure. These and other advantages of the disclosure will be realized and attained by the structure particularly pointed out in the written description and claims hereof as well as the appended drawings.

To achieve these and other advantages and in accordance with the purpose of the present disclosure, as embodied and broadly described herein, a light emitting display apparatus includes a display panel including pixels arranged therein, each pixel including a light emitting diode, a driving transistor configured to be electrically connected to the light emitting diode, and a first capacitor connected between a source electrode and a gate electrode of the driving transistor; a timing control portion including a stress calculation portion which is configured to calculate a stress data representing an amount of stress accumulated in the driving transistor of the pixel using an image data input in a display driving, and a recovery data generation portion which is configured to generate a recovery data corresponding to the calculated stress data in a recovery driving; and a data driving portion which is configured to output a recovery voltage corresponding to the recovery data to a data line, wherein the recovery voltage is configured to be applied to the driving transistor of the pixel such that a gate-source voltage of the driving transistor is in a reverse bias state.

It is to be understood that both the foregoing general description and the following detailed description are examples and explanatory and are intended to provide further explanation of the disclosure as claimed.

### BRIEF DESCRIPTION OF THE DRAWINGS

The accompanying drawings, which are included to provide a further understanding of the disclosure and are incorporated in and constitute a part of this disclosure, illustrate embodiments of the disclosure and together with the description serve to explain the principles of the disclosure. In the drawings:

FIG. 1 is a view schematically illustrating a light emitting display apparatus according to an embodiment of the present disclosure;

FIG. 2 is a circuit view schematically illustrating an example of a pixel of a light emitting display apparatus according to an embodiment of the present disclosure;

FIG. 3 is a view illustrating a configuration of a gate driving portion of a light emitting display apparatus according to an embodiment of the present disclosure;

FIG. 4 is a cross-sectional view schematically illustrating an example of a cross-sectional structure of a display panel according to an embodiment of the present disclosure;

FIG. 5 is a view schematically illustrating a configuration of a timing control portion according to an embodiment of the present disclosure;

FIG. 6 is a view schematically illustrating a gate-source voltage of a driving transistor according to a recovery voltage in a recovery driving according to an embodiment of the present disclosure;

FIG. 7 is a view schematically illustrating a gate-source voltage of a driving transistor according to a reference voltage in a recovery driving according to an embodiment of the present disclosure;

FIG. 8 is a view schematically illustrating a gate-source voltage of a driving transistor according to a reset voltage in a recovery driving according to an embodiment of the present disclosure;

FIG. 9 is a view schematically illustrating a process of implementing a recovery driving of a display apparatus according to an embodiment of the present disclosure;

FIG. 10 is a view illustrating operations in a display driving of a display apparatus according to an embodiment of the present disclosure;

FIG. 11 is a view illustrating operations in a recovery driving of a display apparatus according to an embodiment of the present disclosure; and

FIG. 12 is a view illustrating a driving current over a time in a recovery driving according to an embodiment of the present disclosure and in a driving according to a comparative example.

### DETAILED DESCRIPTION OF THE EMBODIMENTS

Advantages and features of the present disclosure and methods of achieving them will be apparent with reference to the embodiments described below in detail with the accompanying drawings. However, the present disclosure is not limited to the embodiments disclosed below, but can be realized in a variety of different forms, and only these embodiments allow the present disclosure to be complete. The present disclosure is provided to fully inform the scope of the disclosure to the skilled in the art of the present disclosure, and the present disclosure can be defined by the scope of the claims.

The shapes, sizes, proportions, angles, numbers, and the like disclosed in the drawings for explaining the embodiments of the present disclosure are illustrative, and the present disclosure is not limited to the illustrated matters. The same reference numerals refer to the same components throughout the description.

Furthermore, in describing the present disclosure, if it is determined that a detailed description of the related known technology unnecessarily obscure the subject matter of the present disclosure, the detailed description thereof can be omitted. When ‘comprising’, ‘including’, ‘having’, ‘consisting’, and the like are used in this disclosure, other parts can be added unless ‘only’ is used. When a component is expressed in the singular, cases including the plural are included unless specific statement is described.

In interpreting the components, even if there is no separate explicit description, it is interpreted as including a margin range.

In the case of a description of a positional relationship, for example, when the positional relationship of two parts is described as ‘on’, ‘over’, ‘above’, ‘below’, ‘beside’, ‘under’, and the like, one or more other parts can be positioned between such two parts unless ‘right’ or ‘directly’is used.

In the case of a description of a temporal relationship, for example, when a temporal precedence is described as ‘after’, ‘following’, ‘before’, and the like, cases that are not continuous can be included unless ‘directly’ or ‘immediately’ is used. Further, the term “can” fully encompasses all the meanings and coverages of the term “may” and vice versa.

In describing components of the present disclosure, terms such as first, second and the like can be used. These terms are only for distinguishing the components from other components, and an essence, order, order, or number of the components is not limited by the terms.

Respective features of various embodiments of the present disclosure can be partially or wholly connected to or combined with each other and can be technically interlocked and driven variously, and respective embodiments can be independently implemented from each other or can be implemented together with a related relationship.

Hereinafter, embodiments of the present disclosure are described in detail with reference to the drawings. All the components of each display apparatus/device according to all embodiments of the present disclosure are operatively coupled and configured. Meanwhile, in the following embodiments, the same and like reference numerals are assigned to the same and like components, and detailed descriptions thereof can be omitted.

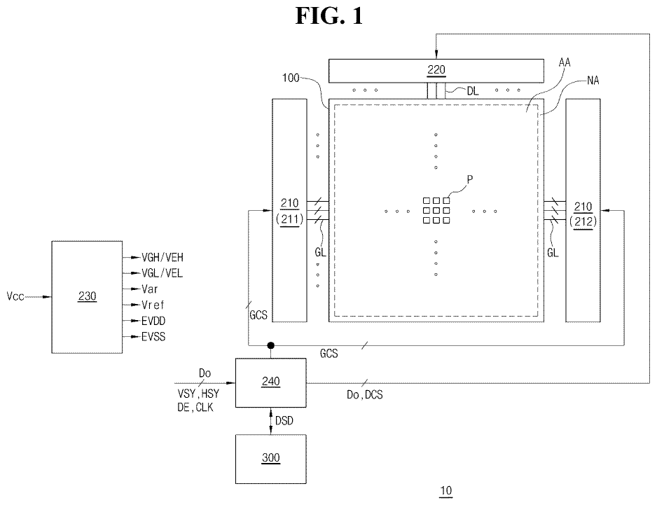

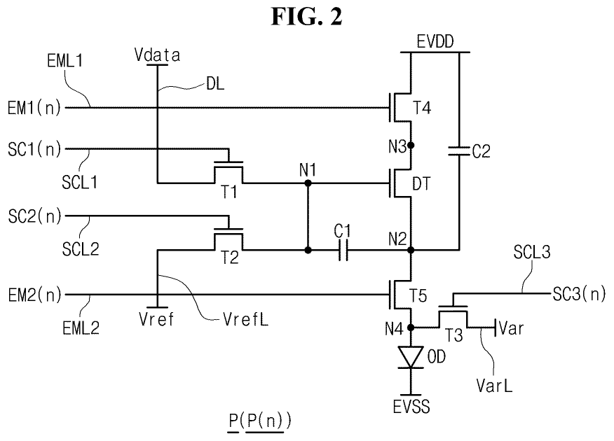

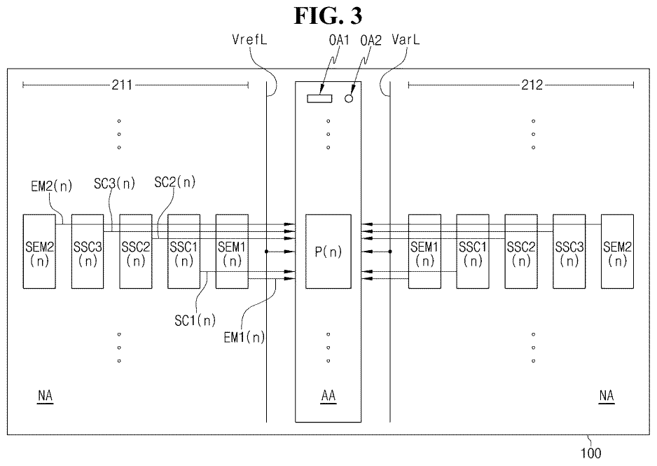

FIG. 1 is a view schematically illustrating a light emitting display apparatus according to an embodiment of the present disclosure. FIG. 2 is a circuit view schematically illustrating an example of a pixel of a light emitting display apparatus according to an embodiment of the present disclosure. FIG. 3 is a view illustrating a configuration of a gate driving portion of a light emitting display apparatus according to an embodiment of the present disclosure.

Prior to a specific description, an organic light emitting display apparatus is described as an example of a light emitting display apparatus 10 according to one or more embodiments of the present disclosure.

Referring to FIGS. 1 to 3, the light emitting display apparatus 10 in this embodiment can include a display panel 100 and a driving circuit portion that drives the display panel 100.

Here, the driving circuit portion can include, for example, a gate driving portion (or gate driving circuit) 210, a data driving portion (or data driving circuit) 220, and a timing control portion (or timing control circuit) 240. In addition, the driving circuit portion can include a power supply portion (or power supply circuit) 230 that supplies power required for driving the display panel 100, the gate driving portion 210, the data driving portion 220, and the timing control portion 240.

Moreover, the light emitting display apparatus 10 of this embodiment can include a memory 300 that stores a degradation stress accumulated in the display panel 100.

The display panel 100 can include a display region (or active area) AA that displays an image, and a non-display region (or non-active area) NA arranged outside the display region AA (or surrounding the display region AA entirely or only in part(s)).

In the display region AA, a plurality of pixels P can be arranged in a matrix form along a plurality of horizontal lines (or row lines) and a plurality of vertical lines (or column lines).

Here, the plurality of pixels P can include pixels that display different colors, for example, red, green, and blue pixels that display red, green, and blue, respectively, but not limited thereto.

In the display panel 100, various signal lines that transmit driving signals for driving the pixels P can be formed on a substrate.

In this regard, for example, a plurality of data lines DL that transmit data signals (or data voltages) which are image signals can extend in the vertical direction and be connected to the pixels P of the respective vertical lines.

In addition, a gate line GL that transmits a gate signal (or gate voltage) can extend in the horizontal direction and be connected to the pixel P of the corresponding horizontal line.

In this embodiment, a plurality of gate signals can be used to drive each pixel P, for example, a first scan signal SC1 to a third scan signal SC3, a first emission control signal EM1, and a second emission control signal EM2 can be used. Accordingly, a plurality of gate lines GL respectively transmitting the plurality of gate signals can be used, for example, a first scan line SCL1 to a third scan line SCL3, a first emission control line EML1, and a second emission control line EML2 can be used.

As such, the plurality of pixels P can be defined by the plurality of data lines DL and gate lines GL intersecting each other.

Each pixel P can include a light emitting diode OD as a light emitting element, and a plurality of transistors and at least one capacitor for driving the light emitting diode OD.

Meanwhile, in this embodiment, for convenience of explanation, an 6T2C structure in which the pixel P is equipped with six transistors T1 to T5 and DT and two capacitors C1 and C2 as illustrated in FIG. 2 is taken as an example. For example, each pixel P in FIG. 1 can have the configuration shown in FIG. 2.

Referring to FIG. 2, each pixel P can include a plurality of switching transistors, for example, first transistor T1 to fifth transistor T5, a driving transistor DT, a first capacitor C1, a second capacitor C2, and the light emitting diode OD.

Each of the first to fifth transistors T1 to T5 and the driving transistor DT can include a first electrode, a second electrode, and a gate electrode. One of the first electrode and the second electrode can be a source electrode, and the other of the first electrode and the second electrode can be a drain electrode.

Each of the first to fifth transistors T1 to T5 and the driving transistor DT can be a P-type or N-type transistor. Meanwhile, in FIG. 2, an example is given in which the first to fifth transistors T1 to T5 are configured as N-type transistors, and the driving transistor DT is configured as a N-type transistor, but not limited thereto.

The first transistor T1 to the fifth transistor T5 and the driving transistor DT can include semiconductors of the same material or can include semiconductors of different materials. In this regard, for example, some of the first transistor T1 to the fifth transistor T5 and the driving transistors DT can have one semiconductor layer among a polycrystalline silicon layer, an oxide semiconductor layer, and an amorphous silicon layer, and another some of the first transistor T1 to the fifth transistor T5 and the driving transistors DT can have another semiconductor layer among a polycrystalline silicon layer, an oxide semiconductor layer, and an amorphous silicon layer.

An oxide semiconductor has excellent off-current characteristics, and a polycrystalline silicon has excellent mobility. In this embodiment, an example is given in which the driving transistor DT can have an oxide semiconductor layer, and each of the first transistor T1 to the fifth transistor T5 can have an oxide semiconductor layer or a polycrystalline silicon layer, but not limited thereto.

The gate signals provided to a n-th horizontal line of FIG. 2 can be provided from a corresponding n-th stage of the gate driving portion 210. For example, three scan signals, first to third scan signals (SC1 to SC3: SC1(n) to SC3(n)) and two emission control signals, first and second emission control signals (EM1 and EM2: EM1(n) and EM2(n)) can be provided. In this case, in the display region AA, first to third scan lines SCL1 to SCL3 and first and second emission control lines EML1 and EML2 that are connected to the n-th stage and transmit the first to third scan signals SC1(n) to SC3(n) and the first and second emission control signals EM1(n) and EM2(n) to the pixel P can be arranged. Here, n can be a real number such as a positive integer.

The first transistor T1 can function as a data supply transistor, the second transistor T2 can function as an initialization transistor, the third transistor T3 can function as a reset transistor, the fourth and fifth transistors T4 and T5 can function as emission control transistors.

The light emitting diode OD can include an anode electrode and a cathode electrode. The anode electrode of the light emitting diode OD can be connected to a fourth node N4, and the cathode electrode of the light emitting diode OD can be applied with a low-potential driving voltage EVSS.

The driving transistor DT can include, for example, a first electrode connected to a second node N2, a second electrode connected to a third node N3, and a gate electrode connected to a first node N1. The driving transistor DT can provide a driving current (or emission current) to the light emitting diode OD based on a voltage of the first node N1 (i.e., a voltage stored in the first capacitor C1).

The first transistor T1 can include a second electrode connected to the data line DL (or receiving the data voltage Vdata), a first electrode connected to the first node N1, and a gate electrode receiving the first scan signal SC1(n). The first transistor T1 can be turned on in response to the first scan signal SC1(n) and can transmit the data voltage Vdata to the first node N1. In this case, the data voltage Vdata can be applied to the gate electrode of the driving transistor DT.

The first capacitor C1 can function as a compensation capacitor. The first capacitor C1 can be connected between the first node N1 and the second node N2. The first capacitor C1 can store and maintain a voltage applied to the gate electrode of the driving transistor DT. Furthermore, a threshold voltage (Vth) of the driving transistor DT can be sampled in the first capacitor C1.

The second transistor T2 can include a second electrode connected to a reference voltage line VrefL that transmits a reference voltage Vref, a first electrode connected to the first node N1, and a gate electrode that receives the second scan signal SC2(n). The second transistor T2 can be turned on in response to the second scan signal SC2(n) and transmit the reference voltage Vref to the first node N1. Accordingly, the gate electrode of the driving transistor DT can be initialized by the reference voltage Vref.

The third transistor T3 can include a second electrode connected to a reset voltage line VarL that transmits a reset voltage (or anode reset voltage) Var, a first electrode connected to the fourth node N4, and a gate electrode that receives the third scan signal SC3(n). The third transistor T3 can be turned on in response to the third scan signal SC3(n) and transmit the reset voltage Var to the fourth node N4. Accordingly, the anode electrode of the light emitting diode OD can be reset by the reset voltage Var.

The fourth transistor T4 can include a second electrode connected to a line that transmits a high-potential driving voltage EVDD, a first electrode connected to the third node N3, and a gate electrode that receives the first emission control signal EM1(n).

The fifth transistor T5 can include a second electrode connected to the second node N2, a first electrode connected to the fourth node N4 (or the anode electrode of the light emitting diode OD), and a gate electrode receiving the second emission control signal EM2(n).

The fourth and fifth transistors T4 and T5 can be turned on in response to the first and second emission control signals EM1(n) and EM2(n), a driving current can be supplied to the light emitting diode OD, and the light emitting diode OD can emit light at a brightness corresponding to the driving current.

The second capacitor C2 can function as an auxiliary capacitor. The second capacitor C2 can be connected between the line transmitting the high-potential driving voltage EVDD and the second node N2.

As described above, the pixel driving circuit driving the pixel P can use a source follower type compensation circuit to compensate for the threshold voltage (Vth) of the driving transistor DT.

When driving the display panel 100 including the pixel P configured as described above, for example, an initialization period (or reset period), a sampling period, a data writing period, and an emission period can be sequentially set for each frame.

In the initialization period, for example, the second and third scan signals SC2(n) and SC3(n) having turn-on levels can be applied to the second and third transistors T2 and T3, so that the second and third transistors T2 and T3 can be turned on, the reference voltage Vref can be provided to the first node N1, and the reset voltage Var can be transmitted to the fourth node N4. Meanwhile, in the initialization period, the first scan signal SC1(n) can have a turn-off level and the first transistor T1 can be turned off, the first emission control signal EM1(n) can have a turn-off level and the fourth transistor T4 can be turned off, and the second emission control signal EM2(n) can have a turn-on level and the fifth transistor T5 can be turned on.

In the sampling period after the initialization period, for example, the second scan signal SC2(n) having a turn-on level can be applied to the second transistor T2 and the second transistor T2 can be turned on, and the reference voltage Vref can be provided to the first node N1. In addition, the first and second emission control signals EM1(n) and EM2(n) having turn-on levels can be applied to the fourth and fifth transistors T4 and T5, so that the fourth and fifth transistors T4 and T5 can be turned on. Accordingly, the threshold voltage (Vth) of the driving transistor DT can be sampled and stored in the first capacitor C1. Meanwhile, in the sampling period, the first scan signal SC1(n) can have a turn-off level to turn off the first transistor T1, and the third scan signal SC3(n) can have a turn-off level to turn off the third transistor T3.

In the data writing period after the sampling period, for example, the first scan signal SC1(n) having a turn-on level can be applied to the first transistor T1, so that the first transistor T1 can be turned on, and the data voltage Vdata can be provided to the first node N1 and be applied to the gate electrode of the driving transistor DT. Meanwhile, in the data writing period, the second scan signal SC2(n) can have a turn-off level to turn off the second transistor T2, the third scan signal SC3(n) can have a turn-off level to turn off the third transistor T3, the first emission control signal EM1(n) can have a turn-off level to turn off the fourth transistor T4, and the second emission control signal EM2(n) can have a turn-off level to turn off the fifth transistor T5.

In the emission period after the data writing period, for example, the first and second emission control signals EM1(n) and EM2(n) having turn-on levels can be applied to the fourth and fifth transistors T4 and T5, so that the fourth and fifth transistors T4 and T5 can be turned on. Accordingly, a driving current corresponding to the data voltage Vdata can be generated through the driving transistor DT and provided to the light emitting diode OD, and the light emitting diode OD can emit light. Meanwhile, in the emission period, the first scan signal SC1(n) can have a turn-off level to turn off the first transistor T1, the second scan signal SC2(n) can have a turn-off level to turn off the second transistor T2, and the third scan signal SC3(n) can have a turn-off level to turn off the third transistor T3.

Meanwhile, the operation of the pixel P as described above in the display driving can be equally applied in a recovery driving described later. In other words, in the recovery driving, an initialization period, a sampling period, a data writing period, and an emission period can be sequentially set for each frame, so that operations in such the periods can be performed. Meanwhile, in the recovery driving, the driving transistor DT can be in a reverse bias state, so that no driving current is generated, and the light emitting diode OD can be in a non-emission state during the emission period.

The 6T2C structure of the pixel P described above is an example, and the pixel P of this embodiment can be configured with a different structure.

Referring to FIG. 1, the timing control portion 240 can process image data Do input from a host system to be suitable for size, resolution, etc. of the display panel 100 and supply the processed image data Do to the data driving portion 220. The timing control portion 240 can generate a gate control signal GCS and a data control signal DCS using synchronization signals input from the host system, for example, a dot clock signal CLK, a data enable signal DE, a horizontal synchronization signal HSY, and a vertical synchronization signal VSY. By supplying the gate control signal GCS and the data control signal DCS generated in this way to the gate driving portion 210 and the data driving portion 220, respectively, the gate driving portion 210 and the data driving portion 220 can be controlled.

The timing control portion 240 can be configured to be combined with various processors, for example, a microprocessor, a mobile processor, an application processor, etc., depending on a device to be mounted.

Meanwhile, the host system can be, for example, a driving system that drives an electronic device to which the light emitting display apparatus 10 is applied. The electronic device can be, for example, one of a TV (Television), a navigation system, a monitor, a mobile device, and a wearable device.

The gate driving portion 210 can receive the gate control signal GCS from the timing control portion 240, generate the gate signals, and sequentially apply the gate signals to the gate lines GL. For example, the gate signals can be sequentially output from the top to the bottom in the vertical direction.

The gate driving portion 210 can be arranged, for example, on at least one side of the display region AA. In this embodiment, a case is taken as an example in which the gate driving portion 210 is configured to include first and second gate driving portions 211 and 212 arranged on both sides of the display region AA, for example, on the left and right sides of the display region AA.

The gate driving portion 210 can be formed directly in the non-display region NA on the substrate of the display panel 100, for example, in a GIP (gate-in panel) structure. In this case, the gate driving portion 210 can be formed during processes of forming elements of the display panel 100.

The gate driving portion 210 configured with the GIP structure can include, for example, a first scan driving circuit that sequentially outputs the first scan signals SC1, a second scan driving circuit that sequentially outputs the second scan signals SC2, a third scan driving circuit that sequentially outputs the third scan signals SC3, a first emission driving circuit that sequentially outputs the first emission control signals EM1, and a second emission driving circuit that sequentially outputs the second emission control signals EM2.

Each of the first scan driving circuit to the third scan driving circuit and the first and second emission driving circuits can be configured with a shift register including a plurality of stages that output respective signals.

The gate driving portion 210 is described with further reference to FIG. 3.

FIG. 3 illustrates a part of the gate driving portion 210, and for convenience of explanation, a configuration of a portion of the gate driving portion 210 that drives the n-th horizontal line of the display region AA is illustrated.

Referring to FIG. 3, in the first gate driving portion 211 of the gate driving portion 210, for example, first to third scan stages SSC1(n) to SSC3(n) that constitute the first to third scan driving circuits, respectively, and first and second emission stages SEM1(n) and SEM2(n) that constitute the first and second emission driving circuits, respectively, can be arranged.

In addition, in the second gate driving portion 212 of the gate driving portion 210, for example, the first to third scan stages SSC1(n) to SSC3(n) that constitute the first to third scan driving circuits, respectively, and the first and second emission stages SEM1(n) and SEM2(n) that constitute the first and second emission driving circuits, respectively, can be arranged.

The arrangement of the first to third scan stages SSC1(n) to SSC3(n) and the first and second emission stages SEM1(n) and SEM2(n) shown in FIG. 3 is an example, and they can be arranged in various combinations in the first and second gate driving portions 211 and 212.

The first scan stage SSC1(n) can generate the first scan signal SC1(n) and output it to the corresponding first scan line SCL1. Accordingly, the pixel P(n) of the n-th horizontal line can be applied with the first scan signal SC1(n).

The second scan stage SSC2(n) can generate the second scan signal SC2(n) and output it to the corresponding second scan line SCL2. Accordingly, the pixel P(n) of the n-th horizontal line can be applied with the second scan signal SC2(n).

The third scan stage SSC3(n) can generate the third scan signal SC3(n) and output it to the corresponding third scan line SCL3. Accordingly, the pixel P(n) of the n-th horizontal line can be applied with the third scan signal SC3(n).

The first emission stage SEM1(n) can generate the first emission control signal EM1(n) and output it to the corresponding first emission control line EML1. Accordingly, the pixel P(n) of the n-th horizontal line can be applied with the first emission control signal EM1(n).

The second emission stage SEM2(n) can generate the second emission control signal EM2(n) and output it to the corresponding second emission control line EML2. Accordingly, the pixel P(n) of the n-th horizontal line can be applied with the second emission control signal EM2(n).

Meanwhile, referring to FIG. 3, the reference voltage line VrefL and the reset voltage line VarL can be arranged between the gate driving portion 210 and the display region AA.

The reference voltage line VrefL and the reset voltage line VarL can respectively supply the reference voltage Vref and the reset voltage Var from the power supply portion 230 to the pixels P within the display region AA.

In FIG. 3, each of the reference voltage line VrefL and the reset voltage line VarL is illustrated as being located on the left or right side of the display region AA, but not limited thereto, and each of the reference voltage line VrefL and the reset voltage line VarL can be located on both sides, and even if located on one side, the location on the left or right side is not limited.

Furthermore, one or more optical regions OA1 and OA2 can be disposed in the display region AA.

The one or more optical regions OA1 and OA2 can be arranged to overlap one or more optical electronic devices, for example, a photographing device such as a camera (or image sensor), and/or a detection sensor such as a proximity sensor and an illuminance sensor. For the operation of the optical electronic device, the one or more optical regions OA1 and OA2 can have a light-transmitting structure formed therein and can have transmittance of a certain level or higher. In other words, a number of pixels P per unit area in the one or more optical regions OA1 and OA2 can be smaller than a number of pixels P per unit area in a regular region excluding the optical regions OA1 and OA2 in the display region AA. For example, a resolution of the one or more optical regions OA1 and OA2 can be lower than a resolution of the regular region within the display region AA.

Referring back to FIG. 1, the data driving portion 220 can receive the image data Do and the data control signal DCS from the timing control portion 240, and in response to the data control signal DCS, the data driving portion 220 can convert the image data Do into analog image data i.e., data voltages Vdata, and outputs them to the respective data lines DL.

The power supply portion 230 can generate DC power required for driving the pixel array and the driving circuit portion of the display panel 100 using, for example, a DC-DC converter. The DC-DC converter can include a charge pump, a regulator, a buck converter, a boost converter, etc.

The power supply portion 230 can receive, for example, a power voltage Vcc that is a driving voltage for driving the light emitting display apparatus 10 from the host system, and generate the DC voltages such as the gate low voltages VGL and VEL, the gate high voltages VGH and VEH, the high-potential driving voltage EVDD, the low-potential driving voltage EVSS, the reference voltage Vref, and the reset voltage Var. The gate low voltages VGL and VEL and the gate high voltages VGH and VEH can be supplied to the gate driving portion 210. The high-potential driving voltage EVDD, the low-potential driving voltage EVSS, the reference voltage Vref, and the reset voltage Var can be supplied in common to the pixels P in the display panel 100.

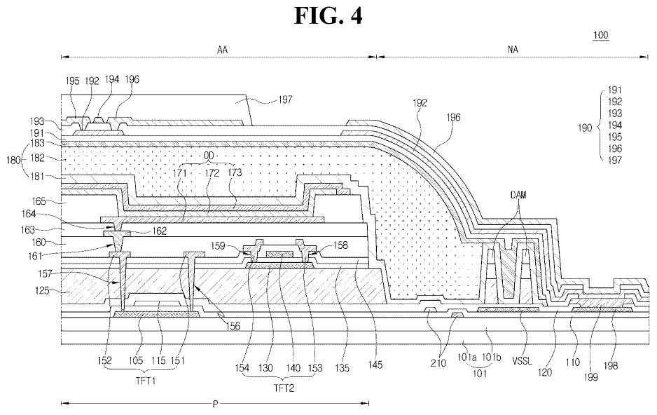

Hereinafter, an example of a cross-sectional structure of the display panel 100 according to this embodiment is described with further reference to FIG. 4.

Particularly, FIG. 4 is a cross-sectional view schematically illustrating an example of a cross-sectional structure of a display panel of a display apparatus according to an embodiment of the present disclosure.

In FIG. 4, for convenience of explanation, two thin film transistors TFT1 and TFT2 are illustrated in the pixel P within the display region AA. Here, the thin film transistor TFT1 positioned relatively lower and closer to the substrate 101 is referred to as a first thin film transistor TFT1, which can be a polycrystalline silicon thin film transistor. The thin film transistor TFT2 positioned relatively upper and farther from the substrate 101 is referred to as a second thin film transistor TFT2, which can be an oxide thin film transistor.

Meanwhile, the first thin film transistor TFT1 can be a fifth transistor (T5 of FIG. 2), but not limited thereto. In addition, the second thin film transistor TFT2 can be a driving transistor (DT of FIG. 2), but not limited thereto.

The substrate 101 can be configured as, for example, a thin glass substrate (or glass film) or a plastic substrate (or plastic film) so as to implement a flexible characteristics of the display panel 100.

Here, in a case where the substrate 101 is configured as a glass substrate, for example, the substrate 101 can have a thickness of approximately 0.2 mm.

In a case where the substrate 101 is configured as a plastic substrate, for example, the substrate 101 can include at least one polyimide layer. In this embodiment, the substrate 101 configured of two polyimide layers, which are a first polyimide layer 101a and a second polyimide layer 101b, is taken as an example.

The first thin film transistor TFT1 can include a first semiconductor layer 105 disposed on the substrate 101, a first gate electrode 115 overlapping the first semiconductor layer 105 with a first insulating layer 110 interposed therebetween, and a first source electrode 151 and a first drain electrode 152 located on a fourth insulating layer 145 over the first gate electrode 115. Here, the first semiconductor layer 105 can be formed of polycrystalline silicon, but not limited thereto.

The first semiconductor layer 105 can include a central channel region and source and drain regions on both sides thereof. The first source electrode 151 and the first drain electrode 152 can be connected to the source region and the drain region of the first semiconductor layer 105 through the first and second contact holes 156 and 157 that are formed in the insulating layers 110, 120, 125, 135, and 145 located below the first source electrode 151 and the first drain electrode 152.

A Second insulating layer 120 can be formed on the first gate electrode 115 of the first thin film transistor TFT1.

A first interlayered insulating layer 125 can be formed on the second insulating layer 120. The second thin film transistor TFT2 can be formed on the first interlayered insulating layer 125.

The second thin film transistor TFT2 can include a second semiconductor layer 130 on the first interlayered insulating layer 125, a second gate electrode 140 overlapping the second semiconductor layer 130 with a third insulating layer 135 interposed therebetween, and a second source electrode 153 and a second drain electrode 154 located on the fourth insulating layer 145 over the second gate electrode 140. Here, the second semiconductor layer 130 can be formed of an oxide semiconductor, but not limited thereto.

The second semiconductor layer 130 can include a central channel region and source and drain regions on both sides thereof. The second source electrode 153 and the second drain electrode 154 can be connected to the source and drain regions of the second semiconductor layer 130 through third and fourth contact holes 158 and 159 formed in the insulating layers 135 and 145 located below the second source electrode 153 and the second drain electrode 154.

A second interlayered insulating layer (or first planarization layer) 160 can be formed on the second thin film transistor TFT2.

Here, the first, second, third, and fourth insulating layers 110, 120, 135, and 145 can be formed of an inorganic insulating material such as silicon nitride or silicon oxide, but not limited thereto.

In addition, the first and second interlayered insulating layers 125 and 160 can be formed of an organic insulating material such as photo acrylic or benzocyclobutene, but not limited thereto.

A connection electrode 162 can be formed on the second interlayered insulating layer 160. The connection electrode 162 can be connected to the first drain electrode 152 through a contact hole 161 formed in the second interlayered insulating layer 160.

A third interlayered insulating layer (or second planarization layer) 163 can be formed on the connection electrode 162. The third interlayered insulating layer 163 can be formed of an organic insulating material such as photo acrylic or benzocyclobutene, but not limited thereto.

The light emitting diode OD and a bank 165 can be formed on the third interlayered insulating layer 163.

The light emitting diode OD can include an anode electrode (or first electrode) 171, a light emitting layer 172, and a cathode electrode (or second electrode) 173.

The anode electrode 171 can be connected to the connection electrode 162 through the contact hole 164 formed in the third interlayered insulating layer 163.

The bank 165 can be disposed along a boundary of the pixel P and can be formed to cover an edge of the anode electrode 171. The light emitting layer 172 can be formed on the anode electrode 171 exposed through an opening of the bank 165.

The cathode electrode 173 can be formed on the light emitting layer 172 and can be applied with the low-potential driving voltage (EVSS of FIG. 2).

An encapsulation layer 180 can be formed on the cathode electrode 173. The encapsulation layer 180 can include at least one inorganic encapsulation layer and at least one organic encapsulation layer, but not limited thereto. In this disclosure, a structure of the encapsulation layer 180, in which a first encapsulation layer 181, a second encapsulation layer 182, and a third encapsulation layer 183 are sequentially stacked, is described as an example.

The first encapsulation layer 181 can be formed on the substrate 101 on which the cathode electrode 173 is formed. The third encapsulation layer 183 can be formed on the substrate 101 on which the second encapsulation layer 182 is formed, and can be formed to surround an upper surface, a lower surface, and a side surface of the second encapsulation layer 182 together with the first encapsulation layer 181. The first encapsulation layer 181 and the third encapsulation layer 183 can minimize or prevent external moisture or oxygen from penetrating into the light emitting diode OD. The first encapsulation layer 181 and the third encapsulation layer 183 can be formed of an inorganic insulating material capable of low-temperature deposition, such as silicon nitride, silicon oxide, silicon oxynitride, or aluminum oxide.

The second encapsulation layer 182 can acts as a buffer to relieve stress between layers due to bending of the light emitting display apparatus 10, and can flatten steps between layers. The second encapsulation layer 182 can be formed on the substrate 101 on which the first encapsulation layer 181 is formed, using a non-photosensitive organic insulating material such as acrylic resin, epoxy resin, phenolic resin, polyamide resin, polyimide resin, polyethylene, or silicon oxycarbon (SiOC), or a photosensitive organic insulating material such as photo acrylic, but not limited thereto. When the second encapsulation layer 182 is formed through an inkjet method, a dam DAM can be placed in the non-display region NA to prevent the second encapsulation layer 182 in liquid form from spreading to an edge of the substrate 101. The dam DAM can be disposed closer to the edge of the substrate 101 than the second encapsulation layer 182. By the dam DAM, the second encapsulation layer 182 can be prevented from spreading to a pad region, where a conductive pad is disposed, on an outermost edge of the substrate 101.

The dam DAM can be designed to prevent the spreading of the second encapsulation layer 182, but if the second encapsulation layer 182 is formed to exceed a height of the dam DAM during a process, the second encapsulation layer 182 as an organic layer can be exposed to an outside, so that moisture, etc. can easily penetrate into the light emitting element. To prevent this, 10 or more dam DAM can be formed in succession, but not limited thereto.

The dam DAM can be formed simultaneously with the first interlayered insulating layer 125, the second interlayered insulating layer 160, and the third interlayered insulating layer 163. When forming the first interlayered insulating layer 125, a lower layer of the dam DAM can be formed together, and when forming the second and third interlayered insulating layers 160 and 163, an upper layer of the dam DAM can be formed together, so that the dam DAM can be formed in a triple laminated structure. As another example, the dam DAM can be formed with one or two of the first, second, and third interlayered insulating layers 125, 160, and 163.

Accordingly, the dam DAM can be formed of the same material as the first interlayered insulating layer 125, the second interlayered insulating layer 160, and the third interlayered insulating layer 163, but not limited thereto.

The dam DAM can be formed to overlap a low-potential driving voltage line VSSL. For example, the low-potential driving voltage line VSSL can be formed at a lower layer of a region, where the dam DAM is located, in the non-display region NA.

The low-potential driving voltage line VSSL and the gate driving portion 210 configured in the GIP structure can be formed along a periphery of the display panel 100, and the low-potential driving voltage line VSSL can be located outside the gate driving portion 210. In addition, the low-potential driving voltage line VSSL can be connected to the cathode electrode 173 to apply the low-potential driving voltage EVSS. The gate driving portion 210 is simply shown in a planar and cross-sectional manner in the drawings, but can be configured with the same structure as the first thin film transistor TFT1 and/or the second thin film transistor TFT2 of the display region AA.

A touch layer (or touch element layer) 190 can be disposed on the encapsulation layer 180. In the touch layer 190, a touch buffer layer 191 can be positioned between a touch sensor metal including touch electrode connection lines 192 and 194 and touch electrodes 195 and 196, and the cathode electrode 173 of the light emitting diode OD.

The touch buffer layer 191 can block a chemical solution (developer, etchant, etc.) used in a manufacturing process of the touch sensor metal disposed on the touch buffer layer 191 or moisture from the outside from penetrating into the light emitting layer 172 containing an organic material. Accordingly, the touch buffer layer 191 can prevent damage to the light emitting layer 172 that is vulnerable to the chemical solution or moisture.

According to a mutual-capacitance-based touch sensor structure, the touch electrodes 195 and 196 can be disposed on the touch buffer layer 191, and the touch electrodes 195 and 196 can be arranged to cross each other.

The touch electrode connection lines 192 and 194 can electrically connect the touch electrodes 195 and 196. One of the touch electrode connection lines 192 and 194, and the touch electrodes 195 and 196 can be located at different layers with a touch insulation layer 193 interposed therebetween. In addition, one of the touch electrode connection lines 192 and 194 and the other of the touch electrode connection lines 192 and 194 can be located at different layers with the touch insulation layer 193 interposed therebetween.

The touch electrode connection lines 192 and 194 can be arranged to overlap the bank 165, thereby preventing decrease in aperture ratio, but not limited thereto.

Meanwhile, a part of the touch electrodes 195 and 196 and a part of the touch electrode connection line 192 can extend along the top and side surfaces of the encapsulation layer 180 and the top and side surfaces of the dam DAM and be electrically connected to a touch driving circuit through a touch pad 198 and 199.

A part of the touch electrodes 195 and 196 and a part of the touch electrode connection line 192 can receive a touch driving signal from the touch driving circuit and transmit it to the touch electrodes 195 and 196, and can transmit a touch sensing signal detected by the touch electrodes 195 and 196 to the touch driving circuit.

In this regard, for example, a driving IC (e.g., data IC, etc.) of the data driving portion 220 including the touch driving circuit can be configured in a COF type and connected to the non-display region NA of the substrate 101 of the display panel 100, and in this case, an end of the touch pad 198 and 199 can be connected to a flexible circuit film on which the driving IC is mounted, so that a signal can be transmitted.

A touch protective layer 197 can be disposed on the touch electrodes 195 and 196. In the drawing, the touch protective layer 197 is shown as being disposed only on the touch electrodes 195 and 196, but not limited thereto, and the touch protective layer 197 can extend before or after the dam DAM to be disposed on the touch electrode connection line 192.

In addition, a color filter can be disposed on the encapsulation layer 180. The color filter can be positioned on the touch layer 190, or between the encapsulation layer 180 and the touch layer 190.

In the light emitting display apparatus 10 of this embodiment, as described above, at least one of the transistors provided in the pixel P, for example, the driving transistor DT can be formed as an oxide transistor including an oxide semiconductor. In this embodiment, for convenience of explanation, the case where the driving transistor DT is formed of an N-type oxide transistor is taken as an example.

The oxide transistor is vulnerable to stress, so that the oxide transistor can have degradation in which a threshold voltage shift occurs as a driving time elapses.

Accordingly, when the driving transistor DT formed of an oxide semiconductor is driven for a long time, a forward-biased, for example, positive-biased, gate-source voltage (i.e., a voltage between a gate electrode and a source electrode) (Vgs) is continuously applied, resulting in a continuous current stress. As a result, a threshold voltage (Vth) of the driving transistor DT can shift, for example, positive-shift.

As such, if a shift phenomenon of the threshold voltage (Vth) of the driving transistor DT occurs and driving characteristics of the driving transistor DT are degraded, a driving current can decrease, which can cause poor image quality such as afterimages or brightness fluctuations.

However, in this embodiment, the stress applied to the driving transistor DT while the light emitting display apparatus 10 is driven by emitting light in a normal mode can be accumulated and calculated, and a recovery driving can be performed in which a reverse bias voltage is applied between the gate electrode and the source electrode of the driving transistor DT during a non-display period (or non-driving period) of the light emitting display apparatus 10.

As such, when a bias voltage of a direction e.g., a negative direction, which is opposite to a forward direction e.g., a positive direction of the gate-source voltage (Vgs) of the driving transistor DT during the display driving (or emission driving), is applied between the gate electrode and the source electrode of the driving transistor DT, the accumulated stress in the driving transistor DT during the display driving can be alleviated by applying a reverse stress due to a reverse bias.

Accordingly, the shift phenomenon of the driving transistor DT can be alleviated by the reverse bias, so that the driving characteristics of the driving transistor DT can be restored.

This recovery driving can be performed repeatedly. For example, the stress applied to the driving transistor DT can be accumulated over a certain period of time, and when a condition for the recovery driving is met in a non-display state, the recovery driving can be performed, and the stress accumulation and the recovery driving can be performed repeatedly.

Accordingly, the stress generated in the driving transistor DT is not continuously accumulated, but can be alleviated and recovered through the repeatedly executed recovery driving, so that the driving transistor DT can substantially maintain its initial driving characteristics.

Therefore, degradation of the driving transistor DT due to stress accumulation can be reduced, and image quality defect such as afterimages or brightness fluctuations caused by the degradation can be reduced.

The recovery driving of this embodiment of the present disclosure is described in more detail below.

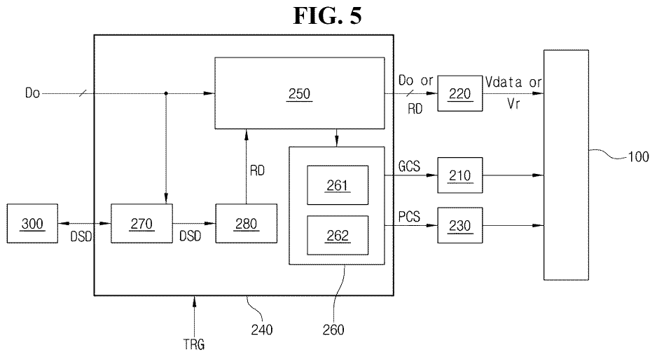

FIG. 5 is a view schematically illustrating a configuration of a timing control portion of a display apparatus according to an embodiment of the present disclosure.

Referring to FIG. 5 along with FIGS. 1 to 4, the timing control portion 240 of this embodiment can include a data output portion (or image output portion or data transmission portion) 250, a driving control portion (or panel driving control portion) 260, a stress calculation portion 270, and a recovery data generation portion 280.

The data output portion 250 can transmit, for example, the image data Do input to the timing control portion 240 to the data driving portion 220 according to a driving timing. Meanwhile, in some cases, the data output portion 250 can signal-process the image data Do.

The driving control portion 260 can, for example, generate and output control signals that control the driving of the display panel 100. In this regard, the driving control portion 260 can include a gate driving control portion 261 that generates a gate control signal GCS controlling the gate driving portion 210, and a power control portion 262 that generates a power control signal PCS controlling the power supply portion 230. Furthermore, the driving control portion 260 can include a data driving control portion that generates a data control signal DCS controlling the data driving portion 220. The driving control portion 260 can be controlled by, for example, the data output portion 250, but not limited thereto.

The stress calculation portion 270 can, for example, receive the image data Do and, based on the image data Do, calculate the accumulated stress data (or degradation stress data) DSD of the driving transistor DT of each pixel P.

For example, as a value (or luminance value or grayscale value) of the image data Do is high, the data voltage Vdata applied to the driving transistor DT increases, thereby increasing the gate-source voltage (Vgs) of the driving transistor DT, resulting an increase of the stress applied to the driving transistor DT.

Furthermore, as the driving time of the light emitting display apparatus 10 increases, the driving time of the driving transistor DT also increases, and thus the stress is accumulated.

Accordingly, based on the input image data Do and the driving time, the stress calculation portion 270 can predict and calculate the stress data DSD of the driving transistor DT accumulated (or generated) up to now. For example, the stress calculation portion 270 can calculate the stress data DSD by frame, and in this case, the stress data DSD of a current frame can be calculated by adding a stress amount induced by the currently input image data Do to the stress data DSD of a previous frame (i.e., immediately preceding frame).

For the stress data DSD, the stress amount can be continuously accumulated and updated during a time when the display driving is performed.

The stress data DSD by pixel P (or for each pixel P) calculated as described above can be configured, for example, in a form of a map, but not limited thereto.

The stress data DSD calculated by the stress calculation portion 270 can be transmitted to the memory 300. The memory 300 can be configured as, for example, a flash memory, but not limited thereto.

The memory 300 can receive the stress data DSD output from the stress calculation portion 270, and update and store it. For example, when the memory 300 receives the current stress data DSD, the memory 300 can update the stress data DSD stored immediately before. In this way, the memory 300 can update and store the accumulated stress amount up to now.

Meanwhile, the stress calculation portion 270 can receive (or read) the stress data DSD stored in the memory 300, and, based on this, calculate the stress data DSD accumulated up to now. For example, the stress calculation portion 270 can read the immediately preceding stress data DSD stored in the memory 300, and, based on this, accumulate an additional stress amount induced by the currently input image data Do.

As such, the stress calculation portion 270 and the memory 300 can transmit and receive the stress data DSD to each other, and calculate and store the accumulated stress amount up to now.

The recovery data generation portion 280 can generate and output recovery data RD which can implement a reverse bias state (or reverse stress state) that alleviates the stress

accumulated in each pixel P when the recovery driving condition is satisfied in the non-display state of the light emitting display apparatus 10.

In this regard, for example, as the driving transistor DT continues to accumulate the stress over time, the threshold voltage (Vth) of the driving transistor Dt can shift positively, for example. To alleviate this positive stress and restore the driving characteristics of the driving transistor DT, the driving transistor DT (more specifically, its gate-source voltage (Vgs)) can be in a reverse bias state, for example, in a negative bias state. Thus, a reverse stress, for example, a negative stress can be applied to the driving transistor DT.

To this end, the recovery data generation portion 280 can generate the recovery data RD which is the compensation data for applying a negative bias state to the driving transistor DT.

In this regard, the recovery data generation portion 280 can, for example, receive and analyze the stress data DSD by pixel P stored in the memory 300 to generate the corresponding recovery data RD by pixel P. Here, the stress data DSD by pixel P stored in the memory 300 can be transmitted to the recovery data generation portion 280 via the stress calculation portion 270, or can be directly transmitted from the memory 300 to the recovery data

generation portion 280.

The value of the recovery data RD can, for example, be inversely proportional to the value of the stress data DSD. In this regard, when the stress amount is high, a large negative bias voltage can be applied (or set) between the gate electrode and the source electrode of the driving transistor DT to alleviate the high stress amount. Accordingly, when the stress amount is high, a recovery voltage Vr provided to the gate electrode of the driving transistor DT can be lowered.

Therefore, the recovery data RD can be set to be inversely proportional to the stress data DSD.

Meanwhile, the recovery data generation portion 280 can be equipped with a lookup table, and when the stress data DSD by pixel P is input, the recovery data generation portion 280 can generate the recovery data RD by pixel P by referencing the lookup table.

Here, the recovery data generation portion 280 can configure the recovery data RD in a form of a map, for example, but not limited thereto.

The recovery data RD by pixel P generated by the recovery data generation portion 280 can be transmitted to the data output portion 250, and the data output portion 250 can transmit the recovery data RD to the data driving portion 220.

When the recovery data RD is input, the data driving portion 220 can generate the recovery voltage Vr which is an analog signal corresponding to the recovery data RD, and output it to the data line DL. The recovery voltage Vr can be transmitted to the corresponding pixel P through the data line DL and applied to the gate electrode of the driving transistor DT.

The gate-source voltage (Vgs) of the driving transistor DT of each pixel P in the display panel 100 can be brought into a negative bias state by the recovery voltage Vr.

Accordingly, the positive stress accumulated in the driving transistor DT can be relieved by the negative stress applied by the recovery voltage Vr, thereby restoring the driving characteristics of the driving transistor DT.

The recovery voltage Vr can have, for example, a turn-off level (or turn-off potential) that turns off the driving transistor DT. Accordingly, during a recovery driving period when the recovery voltage Vr is applied, the light emitting display apparatus 10 can maintain a non-display state i.e., a non-emission state.

In addition, the recovery voltage Vr can have, for example, a level lower than a black level which is the lowest level of the data voltage Vdata in the display driving. In other words, the highest level in a range of voltage levels that the recovery voltage Vr can have can be lower than the lowest level in a range of voltage levels that the data voltage Vdata can have.

As described above, the negative bias voltage can be applied between the gate electrode and the source electrode of the driving transistor DT in the recovery driving, so that a voltage (Vs) of the source electrode of the driving transistor DT can have a relatively higher potential than a voltage (Vg) of the gate electrode of the driving transistor DT.

In this regard, for example, during the recovery driving, the recovery voltage Vr can be applied to the gate electrode of the driving transistor DT (or the first node N1), and the reference voltage Vref and the reset voltage Var can be reflected to the source electrode of the driving transistor DT (or the second node N2).

In this case, the driving transistor DT can be maintained in a turn-off state, and the voltage (Vs) of the source electrode, which reflects the reference voltage Vref and the reset voltage Var, can have a higher potential than the voltage (Vg) of the gate electrode, which reflects the recovery voltage Vr, so that the gate-source voltage (Vgs) of the driving transistor DT can become negatively biased. Accordingly, during the recovery driving, a negative stress can be applied to the driving transistor DT.

As such, the voltage (Vs) of the source electrode of the driving transistor DT can reflect the reference voltage Vref and the reset voltage Var, and the voltage (Vg) of the gate electrode of the driving transistor DT can have the recovery voltage Vr. Therefore, by adjusting (or regulating) the reference voltage Vref and/or the reset voltage Var, or by adjusting (or regulating) the recovery voltage Vr, a level of the negative bias can be adjusted.

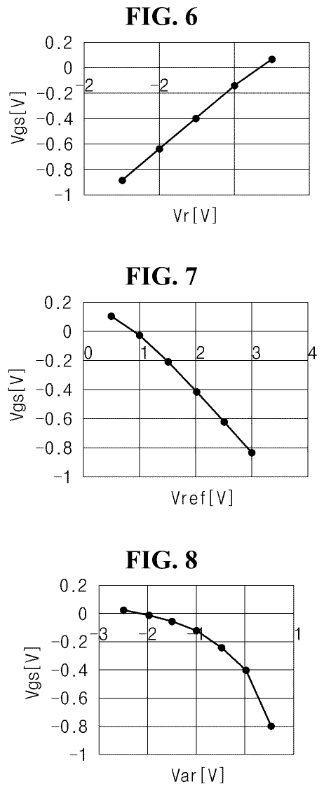

In this regard, further reference can be made to FIGS. 6 to 8. Particularly, FIG. 6 is a view schematically illustrating a gate-source voltage of a driving transistor according to a recovery voltage in a recovery driving according to an embodiment of the present disclosure. FIG. 7 is a view schematically illustrating a gate-source voltage of a driving transistor according to

a reference voltage in a recovery driving according to an embodiment of the present disclosure. FIG. 8 is a view schematically illustrating a gate-source voltage of a driving transistor according to a reset voltage in a recovery driving according to an embodiment of the present disclosure.

Referring to FIG. 6, it can be seen that as the recovery voltage Vr increases, the gate-source voltage Vgs of the driving transistor DT increases in a positive direction.

Referring to FIG. 7, it can be seen that as the reference voltage Vref increases, the gate-source voltage Vgs of the driving transistor DT decreases in a negative direction.

Referring to FIG. 8, it can be seen that as the reset voltage Var increases, the gate-source voltage Vgs of the driving transistor DT decreases in the negative direction.

Accordingly, in the recovery driving, the negative bias state of the driving transistor DT can be strengthened by increasing the reference voltage Vref and/or the reset voltage Var, and the negative bias state of the driving transistor DT can be strengthened by lowering the recovery voltage Vr.

Therefore, the potential of the reference voltage Vref and/or the reset voltage Var can be varied between the recovery driving and the display driving (or normal driving). For example, regarding the reference voltage Vref, a level of the reference voltage Vref during the recovery driving can be set higher than a level of the reference voltage Vref during the display driving. Furthermore, regarding the reset voltage Var, a level of the reset voltage Var during the recovery driving can be set higher than a level of the reset voltage Var during the display driving.

The difference in the reference voltage Vref and/or the reset voltage Var between the recovery driving and the display driving can be implemented, for example, by adjusting the power control signal PCS output from the power control portion 262 of the timing control portion 240.

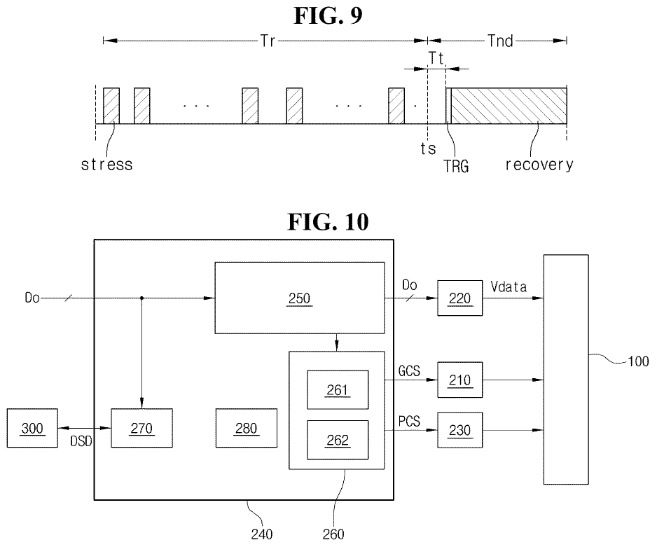

Meanwhile, the recovery driving of this embodiment can be initiated, for example, in response to a trigger signal TRG. This is described with further reference to FIG. 9. FIG. 9 is a view schematically illustrating a process of implementing a recovery driving according to an embodiment of the present disclosure.

Referring to FIG. 9, for example, in the non-display period Tnd (or non-display state) of the light emitting display apparatus 10, when a predetermined period (or trigger period) Tt (e.g., 1 hour) has elapsed from a start time ts of the non-display period Tnd, the trigger signal TRG can be generated. For example, when a predetermined time has elapsed from the start time ts of the non-display state (or non-display mode), such as a charging state (or charging mode), a standby state (or standby mode), or a sleep state (or sleep mode), the trigger signal TRG indicating the start of the recovery driving can be generated.

A component for generating the trigger signal TRG can be provided, for example, in the timing control portion 240 or outside the timing control portion 240.

As such, when the trigger signal TRG is generated and input to the timing control portion 240, in response to the trigger signal TRG, the recovery data generation portion 280 can be activated and perform an operation of generating the recovery data RD.

As such, during the recovery driving period (e.g., 5 hours) when the recovery data RD is generated and the corresponding recovery voltage Vr is output to the display panel 100, the stress calculation portion 270 can be deactivated and the stress calculation operation thereof can be stopped. Here, the recovery driving period can vary depending on the accumulated stress.

Meanwhile, the recovery data generation portion 280 may not generate the recovery data RD when the stress amount of the stress data RD does not exceed a threshold value. In this regard, when the stress amount does not exceed the threshold value, and thus degradation of the driving transistor DT does not occur substantially, the recovery driving may not be performed. Therefore, the recovery data generation portion 280 can stop the data generation operation.

In this case, the stress calculation portion 270 can be activated and can perform the stress calculation operation when the image data Do is input.

Meanwhile, the recovery driving (or generation of the trigger signal TRG) can be implemented, for example, after a set reference period Tr (e.g., 24 hours) has elapsed. In this regard, for example, the reference period Tr, which is the minimum period for stress accumulation calculation, can be set, and if the reference period Tr has elapsed and then the non-display state begins, as mentioned above, the trigger signal TRG can be generated when the predetermined period Tt has elapsed from the start time ts of the non-display state, and the recovery driving can begin.

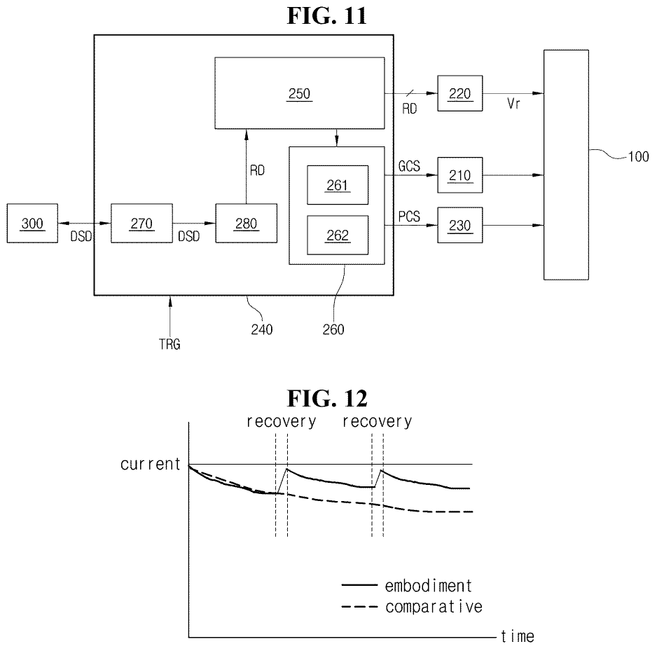

Hereinafter, the display driving and the recovery driving according to an embodiment of the present disclosure are described with further reference to FIGS. 10 and 11. FIG. 10 is a view illustrating operations in a display driving for a display apparatus according to an embodiment of the present disclosure. FIG. 11 is a view illustrating operations in a recovery driving for a display apparatus according to an embodiment of the present disclosure.

First, referring to FIG. 10, the light emitting display apparatus 10 can perform the display driving to display images when the image data Do is input in a normal mode.

In this regard, the data output portion 250 in the timing control portion 240 can transmit the input image data Do to the data driving portion 220.

The stress calculation portion 270 can repeatedly calculate the stress data DSD representing the accumulated stress amount for each pixel P using the input image data Do. The stress data DSD calculated in this way can be transmitted to the memory 300 and updated.

Meanwhile, the data driving portion 220 can receive the image data Do, generate the corresponding data voltage Vdata, and output the data voltage Vdata to the data line DL. The data voltage Vdata can be transmitted to the corresponding pixel P during the data writing period and applied to the gate electrode of the driving transistor DT. Accordingly, a driving current corresponding to the data voltage Vdata can be generated during the emission period and applied to the light emitting diode OD, and the light emitting diode OD can generate and output light with a brightness corresponding to the driving current.

Next, referring to FIG. 11, after the normal mode of the light emitting display apparatus 10 has elapsed for the set reference period Tr or longer, the non-display state begins, and when the set predetermined period Tt has elapsed from the start time ts of the non-display state, the trigger signal TRG can be generated, the recovery mode can be started, and the recovery driving can be performed.

In this regard, when the trigger signal TRG is generated and input to the timing control portion 240, the recovery data generation portion 280 can be activated in response to the trigger signal TRG, and an operation of generating the recovery data RD can be performed.

In this regard, the recovery data generation portion 280 can receive and analyze the stress data DSD for each pixel P stored in the memory 300 to generate the corresponding recovery data RD for each pixel P.

For example, the recovery data generation portion 280 can use the lookup table to generate the recovery data RD for each pixel P corresponding to the stress data DSD for each pixel P.

The recovery data RD can be transmitted to the data output portion 250, and the data output portion 250 can transmit the recovery data RD to the data driving portion 220.

The data driving portion 220 can receive the recovery data RD, generate the corresponding recovery voltage Vr, and output the recovery voltage Vr to the data line DL. The recovery voltage Vr can be transferred to the pixel P during the data writing period and applied to the gate electrode of the driving transistor DT.

Due to the recovery voltage Vr, the gate-source voltage Vgs of the driving transistor DT of each pixel P of the display panel 100 can be brought into a negative bias state.

Therefore, the positive stress accumulated in the driving transistor DT can be alleviated by the negative stress caused by the recovery voltage Vr, so that the driving characteristics of the driving transistor DT can be restored.

Here, the recovery voltage Vr can have, for example, a turn-off level (or turn-off potential) that turns off the driving transistor DT. Accordingly, during the recovery driving period when the recovery voltage Vr is applied, the light emitting display apparatus 10 can maintain the non-display state i.e., a non-emission state. In this regard, the driving transistor DT can have the negative bias state, thus the driving transistor DT can be turned off during the emission period after the data writing period, so that no driving current is generated, allowing the light emitting diode OD to remain in the non-emission state.

FIG. 12 is a view illustrating a driving current over a time in a recovery driving according to an embodiment of the present disclosure and in a driving according to a comparative example.

Referring to FIG. 12, the comparative example is a case where a recovery driving is not applied. In the comparative example, stress continuously accumulates in the driving transistor DT over time, causing a shift in a threshold voltage (Vth) of the driving transistor DT, resulting in a decrease in driving current. This leads to poor image quality such as afterimages and

brightness fluctuations.

Conversely, in this embodiment of the present disclosure, the recovery driving, which applies the reverse bias voltage between the gate electrode and the source electrode of the driving transistor DT to alleviate the accumulated stress, can be repeatedly applied. Accordingly, the accumulated stress in the driving transistor DT can be alleviated by applying the reverse stress due to the reverse bias.

Accordingly, the driving transistor DT can substantially maintain its initial driving characteristics, allowing the driving current to return to its initial state in the present disclosure.

Therefore, according to aspects of the present disclosure, degradation of the driving transistor DT due to the accumulated stress can be reduced, and poor image quality such as afterimages and brightness fluctuations caused by the degradation can be improved.

As described above, in the embodiment of the present disclosure, the stress applied to the driving transistor while the light emitting display apparatus is driven by emitting light can be accumulated and calculated, and the recovery driving can be repeatedly performed in which the reverse bias voltage is applied between the gate electrode and the source electrode of the driving transistor during the non-display period of the light emitting display apparatus.

Accordingly, the accumulated stress in the driving transistor can be alleviated by applying the reverse stress, so that the driving transistor can substantially maintain its initial driving characteristics, allowing the driving current to recover to its initial state.

Therefore, according to aspects of the present disclosure, degradation of the driving transistor due to the accumulated stress can be reduced or minimized, and poor image quality such as afterimages and brightness fluctuations caused by the degradation can be improved.

It will be apparent to those skilled in the art that various modifications and variation can be made in the present disclosure without departing from the spirit or scope of the disclosure. Thus, it is intended that the present disclosure cover the modifications and variations of this disclosure provided they come within the scope of the appended claims and their equivalents.

What is claimed is:

1. A light emitting display apparatus, comprising:
a display panel including pixels arranged therein, each of the pixels including a light emitting diode, a driving transistor configured to be electrically connected to the light emitting diode, and a first capacitor connected between a source electrode and a gate electrode of the driving transistor;
a timing control portion including a stress calculation portion and a recovery data generation portion, the stress calculation portion being configured to calculate stress data representing an amount of stress accumulated in the driving transistor of the pixel using an image data input in a display driving, the recovery data generation portion being configured to generate recovery data corresponding to the calculated stress data in a recovery driving; and
a data driving portion configured to output a recovery voltage corresponding to the recovery data to a data line,
wherein the recovery voltage is configured to be applied to the driving transistor of the pixel so that a gate-source voltage of the driving transistor is in a reverse bias state.

2. The light emitting display apparatus of claim 1, further comprising a memory configured to receive and store the stress data.

3. The light emitting display apparatus of claim 1, wherein the driving transistor includes an oxide semiconductor.

4. The light emitting display apparatus of claim 3, wherein the driving transistor is configured as an N-type transistor.

5. The light emitting display apparatus of claim 4, wherein each of the pixels further includes:
a first transistor connected to the gate electrode of the driving transistor at a first node, and connected to the data line;
a second transistor connected to the first node and configured to receive a reference voltage;
a fifth transistor connected to the source electrode of the driving transistor at a second node;
a third transistor connected to a fourth node between the fifth transistor and the light emitting diode, and configured to receive a reset voltage; and
a fourth transistor connected to a drain electrode of the driving transistor at a third node, and configured to receive a high-potential driving voltage.

6. The light emitting display apparatus of claim 5, wherein the reset voltage in the recovery driving has a higher level than the reset voltage in the display driving.

7. The light emitting display apparatus of claim 5, wherein the reference voltage in the recovery driving has a higher level than the reference voltage in the display driving.

8. The light emitting display apparatus of claim 1, wherein the recovery voltage has a level configured to turn off the driving transistor.

9. The light emitting display apparatus of claim 1, wherein the recovery data generation portion is configured to perform an operation of generating the recovery data in response to a trigger signal.

10. The light emitting display apparatus of claim 9, wherein the trigger signal is configured to be generated when a predetermined time has elapsed from a start of a non-display state of the display panel.

11. The light emitting display apparatus of claim 10, wherein the recovery driving is configured to be performed after a predetermined reference period has elapsed.

12. The light emitting display apparatus of claim 11, wherein the stress calculation portion performs an operation of calculating the stress data in the predetermined reference period, and
wherein in the non-display state after the predetermined reference period has elapsed, the recovery driving is configured to be performed according to the trigger signal.

13. The light emitting display apparatus of claim 1, wherein as the recovery voltage increases, the gate-source voltage of the driving transistor increases in a positive direction.

14. The light emitting display apparatus of claim 5, wherein as the reset voltage increases, the gate-source voltage of the driving transistor decreases in a negative direction.

15. The light emitting display apparatus of claim 5, wherein as the reference voltage increases, the gate-source voltage of the driving transistor decreases in a negative direction.

16. The light emitting display apparatus of claim 1, wherein each of the pixels has an 6T2C structure having six transistors and two capacitors.

17. A light emitting display apparatus, comprising:
a display panel including pixels, one pixel among the pixels having a light emitting diode and a driving transistor configured to be drive the light emitting diode;
a timing controller including a stress calculation portion and a recovery data generation portion, the stress calculation portion being configured to calculate stress data representing an amount of stress accumulated in the driving transistor of the one pixel using an image data input in a display driving, the recovery data generation portion being configured to generate recovery data corresponding to the calculated stress data in a recovery driving;
a data driving portion configured to output a recovery voltage corresponding to the recovery data to a data line; and
a memory configured to store the stress data,
wherein the recovery voltage is configured to be applied to the driving transistor of the one pixel so that a gate-source voltage of the driving transistor is in a reverse bias state.

18. The light emitting display apparatus of claim 17, wherein the recovery voltage has a level configured to turn off the driving transistor.
